(19) United States
(12) Patent Application Publication
(10) Pub. No.: US 2004/0037030 A1
(43) Pub. Date: Feb. 26, 2004

(54) Notebook computer expansion recess structure

(75) Inventors: Andy Kuo, Taipei (TW); Gary Cheng, Taipei (TW)

Correspondence Address: BACON & THOMAS, PLLC, 625 SLATERS LANE, FOURTH FLOOR, ALEXANDRIA, VA, 22314

(73) Assignee: Inventec Corporation, Taipei (TW)

(21) Appl. No.: 10/226,142

(22) Filed: Aug. 23, 2002

(51) Int. Cl. G06F 1/16

(52) U.S. Cl. 361/683; 361/684

(57) ABSTRACT

The invention is to provide a notebook computer expansion recess structure, which consists of a minimum of one expansion recess having a lid in the control panel of a notebook computer such that after the said lid is opened, the said mainboard is exposed in the said expansion recess, enabling the direct replacement or additional installation of electronic components on the said mainboard via the expansion recess and, as such, the consumer or maintenance personnel is not required to disassemble the main system case of the said notebook computer to effect removal.

### BACKGROUND OF THE INVENTION

1. Field of the Invention

The invention herein relates to a notebook computer expansion recess structure.

2 Description of the Prior Art

The contemporary world is in an age of rich information growth and the rapid development of computer-generated information products, which are resulting in virtually unlimited benefits that is inseparable from our lives. Since information product performance and quality requirements have become higher by popular demand as new models of them, especially portable computers, are continually released, whether manufacturers of portable computers (such as notebook computers) can develop new products capable of effectively providing more convenience and performance has become a major indicator in the evaluation of a manufacturer's production technology that will determine the extent of its lead in the market.

In the present stage of the notebook computer research and development, the primary goals of research and development has in addition to a continuous focus on lighter, thinner, shorter, and more compact designs also included a constant emphasis on all-in-one designs. Looking at the present information market and the fierce degree of sales competition therein, needless to say, given the countless brands of notebook computers available on the information market, although each company is under enormous pressure to achieve marketing gains, this situation has doubtlessly also increased consumer selection opportunities in a market where most consumers are looking forward to reasonable prices in the selection of an all-in-one notebook computer that is multifunctional and ergonomic.

As a result, the capability to offer ergonomic, multifunctional all-in-one notebook computers at reasonable prices will be another major factor of competition among computer companies.

A notebook computer, by definition, resembles a notebook that can be opened or closed and, furthermore, its compact and lightweight physical design allows the said notebook computer to be easily carried about. A said notebook computer consists of a screen and a main system case, a minimum of one hinge pin conjoining the screen to the main system case, a control panel on the said main system case that is adjacent to the surface of the said screen, and a keyboard module disposed in the said control panel. The said control panel is covered by the said screen and when the user wants to utilize the said notebook computer, the said screen is rotated on the said hinge pin to a position that enables operational access to the said control panel, at which time operating the said keyboard module inputs data to the said computer, with the said screen displaying the related information.

If the dimensions of the said screen are considerably larger or smaller than that of the said main system case, the exterior appearance of the said notebook computer becomes extremely imbalanced and rather unusual. The surface area of the said screen is therefore exactly the same as that of the surface of the main system case, enabling the said screen to cover the surface of the said main system case such that it becomes unitarily integrated with the said main system case. As such, the said notebook computer is thus afforded a more coordinated appearance.

In other words, if a better visual effect is desired when screen dimensions are increased, the dimensions of the said main system case must also be enlarged. Conversely, if a smaller said notebook computer is desired to facilitate portability, the dimensions of the said screen and the said main system case will have to be proportionately reduced, which results in the following problems.

Although the trend in current high technology products are lightweight, thin, short, and compact designs, if the dimensions the said screen are designed too small, most consumers will have to strain when viewing such a screen. Therefore, the dimensions of the said screen should at least be acceptable to the vision of most people and the surface dimensions of the said main system case must proportionately match the size of the said screen.

However, the said keyboard module actually does not occupy the entire surface area of the said control panel and after the surface area taken up by the said keyboard module in the surface of the said main system case is deducted, there still remains much unused surface area. Although pointer control devices (such as a pointing stick, a touch pad, or a track ball) are sometimes inset in the surface of the said main system case, considerable unused surface area remains available. Similarly, much space remains within the interior section of the said main system case after the physical area occupied by the mainboard and its floppy and hard disk drive is deducted.

Furthermore, conventional notebook computers require that the said main system case be disassembled before replacing or additionally installing electronic components on the said mainboard, which to consumers and maintenance personnel poses quite an inconvenience. If a notebook computer, with respect to the vacant space within the interior section of the said main system case and the remaining surface area on the surface of the said main system case that are available for accessories and utilization, enables consumers to replace electronic components on the said mainboard or expand the said mainboard with compatible electronic components such that the objective is easily achieved, this would not only broaden consumer convenience in an unlimited manner but also be a significant contribution to information technology.

### SUMMARY OF THE INVENTION

Given the penetrating introduction provided in the discussion of the prior art, we know about the screen and main system case of conventional notebook computers, wherein the dimensions of the said screen directly affect the dimensions of the said main system case such that the control panel disposed on the said main system case not only accommodates a keyboard module and a pointer device, but also leaves considerable unused surface area and, furthermore, the interior section of the said main system case, deducting the mainboard and even the floppy and hard disk drive therein, also has considerable unused space remaining, which runs contrary to the current research and development theme of various computer manufacturers to develop the ideal notebook computer, given the constant emphasis on all-in-one designs among their research and development objectives.

In view of the said shortcomings as well as the research and development trends in current information technology, the inventor of the invention herein conducted long-term, extensive research and experimentation that culminated in the successful development and design of the notebook computer expansion recess structure of the invention herein that consists of a minimum of one expansion recess having a lid in the control panel of a notebook computer such that after the said lid is opened, the said mainboard is exposed in the said expansion recess, enabling the direct replacement or additional installation of electronic components on the said mainboard via the expansion recess and, as such, the consumer or maintenance personnel is not required to disassemble the main system case of the said notebook computer to effect removal.

The above and other objects, features and advantages of the present invention will become apparent from the following detailed description taken with the accompanying drawings.

### BRIEF DESCRIPTION OF THE DRAWINGS

FIG. 1 is an isometric drawing of the invention herein.

FIG. 2 is an isometric drawing of the invention herein.

### DETAILED DESCRIPTION OF THE INVENTION

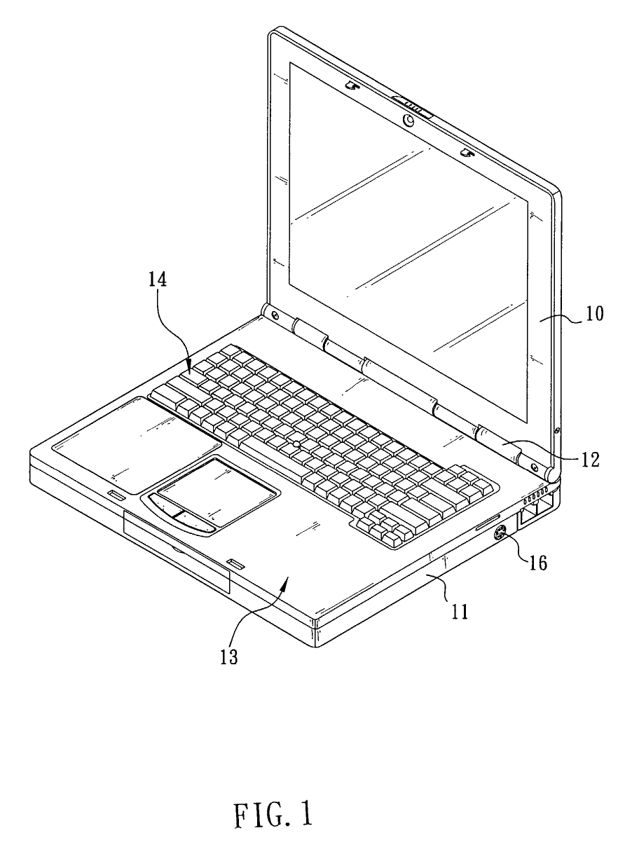

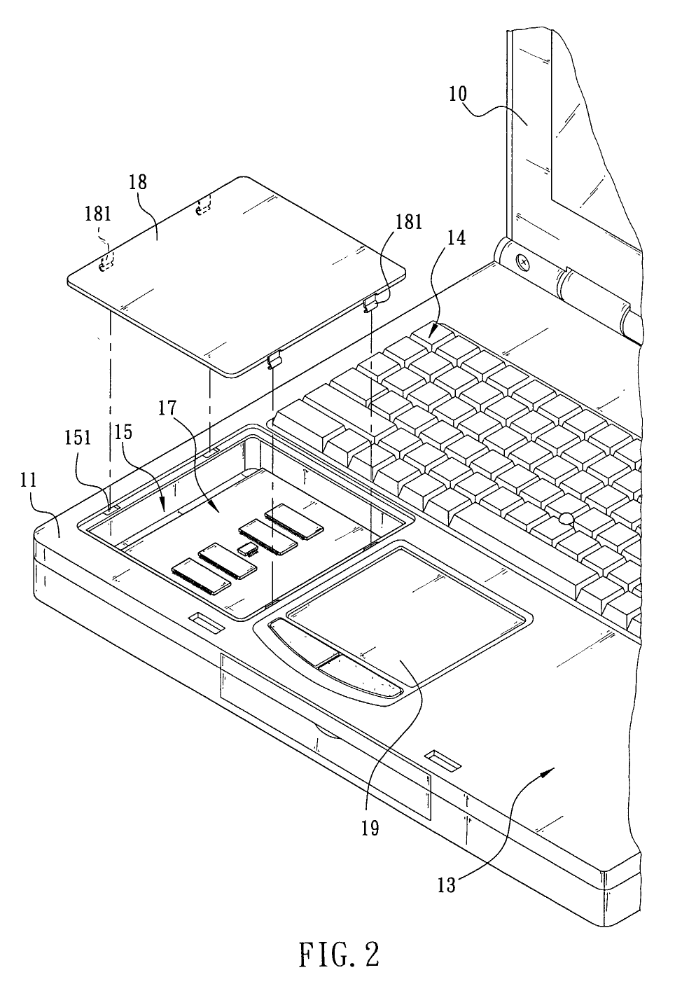

The notebook computer expansion recess structure of the invention herein, referring to FIG. 1 and FIG. 2, is comprised of a screen 10 and a main system case 11, and a minimum of one hinge component 12 installed at one end of the said main system case 11 that conjoins it to the said screen 10, enabling the said screen 10 to be covered over the said main system case 111 and, furthermore, the rotation of said screen 10 on the said hinge component 12 until an appropriate operating position is reached, wherein a mainboard 17 is installed within the interior section of the said main system case 11, a control panel 13 is disposed adjacent to one surface of the said screen 10 along the exterior section of the said main system case 11, a keyboard module 14 is inset in the said control panel 13 proximal to one end of the said screen 10, and a minimum of one expansion recess 15 contiguous to the said mainboard 17 is formed at the other end of the said screen 10; said expansion recess 15 is covered by a lid 18 and after the said lid 18 is opened, a portion of the said mainboard 17 is exposed in the said expansion recess 15, enabling the consumer or maintenance personnel to directly replace or additionally install electronic components on the said mainboard 17 via the each said expansion recess 15.

In the said embodiment, referring to FIG. 1 and FIG. 2, each said lid 18 has a minimum of one fastening component 181 and another fastening component 151 is disposed adjacent to each said expansion recess 15 in the said control panel 13 in an arrangement matching that of the said fastening component 181, enabling the latching of each said lid 18 onto the said control panel 13 to cover each said expansion recess 15 as well as removal from the said control panel 13, wherein each said fastening component 181 consists of a projecting hook and each other fastening component 151 consists of an indented engagement slot.

In the said embodiment, referring to FIG. 1 and FIG. 2, numerous electronic components are installed within the said expansion recess 15 and, essentially, it is only necessary that the said electronic components are capable of being physically installed inside the said expansion recess 15 and, furthermore, supported by the said mainboard 17, for example, a rechargeable battery pack which can be a NI-Cd battery, a Ni-MH battery, a Li-Ion battery, or a compound battery; additionally, the said electronic components can be memory chips to increase the random access memory capacity of the said notebook computer, a Blue Tooth wireless communications module to equip the said notebook computer with wireless transmission capability, or a hard disk drive such as the TREK Thumb Drive, a miniature hard disk drive, released by Japan that has hot insertion and hot swapping capability, utilizes a Universal Serial Bus (USB) interface, weighs only 30 grams, and measures 45 mm (L)×17 mm (W)×4.5 mm (H), the removal of its outer enclosure reducing physical size and weight further enhancing the versatility of the internal circuit board by enabling installation in the said expansion recess 15.

In the said embodiment, referring to FIG. 1 and FIG. 2, the said keyboard module 14 can be a membrane keyboard and a minimum of one pointing device 19 is installed on the said control panel 13; the said pointing device 19 can be an input device that controls the movement of a pointer on the said screen 10 and has the same function as a mouse and, therefore, can be a pointing stick which is also known as a track point, a touch pad, or a track ball.

In the embodiment herein, referring to FIG. 1 and FIG. 2, a minimum of one input port 16 connected to the said mainboard 17 is situated at one side of the said main system case 11 enables the connection of an external input device to the said mainboard 17 via the said input port 16, wherein the said input port 16 can be a USB interface and said input device can be a mouse.

While the invention has been described by means of specific embodiments, numerous modifications and variations could be made thereto by those skilled in the art without departing from the scope and spirit of the invention set forth in the claims.

1. A notebook computer expansion recess structure comprised of:
a main system case having an internally installed mainboard;
a screen that is pivotably conjoined to one end of the said main system case;
a control panel disposed adjacent to one surface of the said screen on the said main system case;
a keyboard module inset in the said control panel proximal to one end of the said screen;
a minimum of one expansion recess formed at the other end of the said screen that is contiguous to the said mainboard such that a minimum of one electronic component can be installed in each said expansion recess and connected to the said mainboard;
a minimum of one lid that is aligned with each said expansion recess in the said control panel to cover each said expansion recess.

2. A notebook computer expansion recess structure as claimed in claim 1 in which the said electronic component can be a rechargeable battery.

3. A notebook computer expansion recess structure as claimed in claim 1 in which the said electronic component can be memory chips.

4. A notebook computer expansion recess structure as claimed in claim 1 in which the said electronic component can be a hard disk drive.

5. A notebook computer expansion recess structure as claimed in claim 1 in which each said lid has a minimum of one fastening component and another fastening component is disposed adjacent to each said expansion recess in the said control panel in an arrangement matching that of the said fastening component, enabling the latching of each said lid onto the said control panel.

6. A notebook computer expansion recess structure as claimed in claim 5 in which each said fastening component consists of a projecting hook and each said other fastening component consists of an indented engagement slot.
